(19) United States
(12) Patent Application Publication
(10) Pub. No.: US 2013/0220619 A1
(43) Pub. Date: Aug. 29, 2013

(54) Methods For High Solid Content Fluids in Oilfield Applications

(71) Applicants: Yiyan Chen, Sugar Land, TX (US); Hongren Gu, Sugar Land, TX (US); Xiaowei Weng, Katy, TX (US); Peter J. Photos, El Campo, TX (US); Mohan K.R. Panga, Novosibirsk (RU)

(72) Inventors: Yiyan Chen, Sugar Land, TX (US); Hongren Gu, Sugar Land, TX (US); Xiaowei Weng, Katy, TX (US); Peter J. Photos, El Campo, TX (US); Mohan K.R. Panga, Novosibirsk (RU)

(73) Assignee: SCHLUMBERGER TECHNOLOGY CORPORATION, Sugar Land, TX (US)

(21) Appl. No.: 13/697,466

(22) PCT Filed: May 6, 2011
(86) PCT No.: PCT/US11/35464

§ 371 Date: May 10, 2013

Related U.S. Application Data
(60) Provisional application No. 61/395,336, filed on May 12, 2010.

(51) Int. Cl. C09K 8/62; E21B 43/26

(52) U.S. Cl. CPC C09K 8/62; E21B 43/26
USPC 166/308.1; 166/305.1

(57) ABSTRACT

The invention discloses a method for use in a wellbore, comprising: providing a first fluid comprising at least a first type of particulate material having a first average particle size and a second type of particulate material having a second average particle size, wherein first average particle size is smaller than second average particle size; providing a second fluid comprising at least a third type of particulate material having a third average particle size and a fourth type of particulate material having a fourth average particle size, wherein third average particle size is smaller than fourth average particle size; and introducing the first fluid into the wellbore subsequently followed by introducing the second fluid into the wellbore, wherein the third average particle size is substantially equal to the second average particle size.

### FIELD OF THE INVENTION

The invention relates to methods for treating subterranean formations. More particularly, the invention relates to methods for optimizing content of particulate material in a fluid.

### BACKGROUND

The statements in this section merely provide background information related to the present disclosure and may not constitute prior art.

Hydrocarbons (oil, condensate, and gas) are typically produced from wells that are drilled into the formations containing them. For a variety of reasons, such as inherently low permeability of the reservoirs or damage to the formation caused by drilling and completion of the well, the flow of hydrocarbons into the well is undesirably low. In this case, the well is “stimulated” for example using hydraulic fracturing, chemical (usually acid) stimulation, or a combination of the two (called acid fracturing or fracture acidizing).

In hydraulic and acid fracturing, a first, viscous fluid called the pad is typically injected into the formation to initiate and propagate the fracture. This is followed by a second fluid that contains a proppant to keep the fracture open after the pumping pressure is released. Granular proppant materials may include sand, ceramic beads, or other materials. In “acid” fracturing, the second fluid contains an acid or other chemical such as a chelating agent that can dissolve part of the rock, causing irregular etching of the fracture face and removal of some of the mineral matter, resulting in the fracture not completely closing when the pumping is stopped. Occasionally, hydraulic fracturing can be done without a highly viscosified fluid (i.e., slick water) to minimize the damage caused by polymers or the cost of other viscosifiers.

In gravel packing, gravel is placed in the annulus of screen and formation/casing to control sand production. A carrier fluid is used to transport gravel from the surface to the formation where the gravel has to be placed. Typically two types of carrier fluids are used. The first is a brine with a low concentration of gravel (1 lb per gal of brine) and the second is a viscous fluid with high concentration of gravel (5 lb per gal of brine). Several types of viscosifiers are used to increase the viscosity of the fluid. These include polymers such as HEC, Xanthan, Guar etc and viscoelastic surfactants.

The transport of solids (proppant, gravel, or other particulate material) from the surface to the required depth in the well and into the formation plays an important role in well stimulations. High solid content fluids (HSCF) can be used. The fluids are formulated with appropriate amount and size distributions of different particles to give stable slurry that can suspend and transport proppant. The use of gelling agent can be significantly reduced if not completely eliminated.

The application in hydraulic fracture needs this fluid to initiate and propagate fracture in the underground formation. In order for the HSCF to enter the fracture, the fracture width created must reach a certain value before the fluid can enter the fracture due to large particle size and concentration. When pumping starts at the beginning of a hydraulic fracturing treatment, the pressure in the wellbore is increased and the rock formation is broken down. A hydraulic fracture is initiated in the rock formation. The initial fracture width is very small because of the small fracture size (length and height of a vertical fracture). The initial fracture may not admit HSCF particles of sizes larger than a fraction (¼ to ⅓) of the fracture width. As the treatment continues (if certain amount of fluid, e.g., particle free pad in conventional hydraulic fracturing, enters the initial fracture), the fracture grows in length, height and width. To maintain the same net pressure, the pumping pressure also increases due to the increased fluid friction pressure inside the fracture. The fracture width is proportional to the fluid pressure inside the fracture and to the fracture dimension (height of a long fracture or radius of a penny shaped fracture). Therefore, the fracture width increases and eventually becomes large enough to admit large size particles.

In conventional hydraulic fracture, this issue is resolved by using a particle free PAD fluid before the slurry, and gradually increases proppant concentration during the pumping process. With enough PAD pumped into the fracture, the width of the fracture will be enough to accommodate the proppant particles and PAD for leak off as well. It would be intuitive to use a PAD with the HSCF fracturing as well but there are several main issues in doing that. Two main issues are listed below.
Due to the high solid content hindered settling nature of the HSCF fluid, water content of HSCF must be strictly controlled. Because there is very limited gelling agent in the system, the HSCF system has no ability to prevent any water from entering and consequently mess up the formulation which leads to proppant settling. Therefore, using a conventional PAD in front of the HSCF fluid will not work if the mixing issue cannot be resolved.
The relative fluid additive (especially gelling agent) chemistry free feature of the HSCF allows some significant benefits, such as fracture damage free and ability to extend the application to any temperature. Using a PAD which requires fluid additive again will defeat these advantages.

This disclosure herewith is intend to address the listed issues and designs an unconventional fluid pumping process and formulations to enable HSCF fracturing applications. Methods disclosed herewith offer a new way to viscosify the fluid while it is under downhole conditions and to use this fluid to initiate and propagate a fracture.

### SUMMARY

In a first aspect, a method for use in a wellbore, comprises: providing a first fluid comprising at least a first type of particulate material having a first average particle size and a second type of particulate material having a second average particle size, wherein first average particle size is smaller than second average particle size; providing a second fluid comprising at least a third type of particulate material having a third average particle size and a fourth type of particulate material having a fourth average particle size, wherein third average particle size is smaller than fourth average particle size; and introducing the first fluid into the wellbore subsequently followed by introducing the second fluid into the wellbore, wherein the third average particle size is between the first average particle size and the second average particle size.

In a second aspect, a method for use in a wellbore, comprises: providing a first fluid comprising at least a first type of particulate material having a first average particle size and a second type of particulate material having a second average particle size, wherein first average particle size is smaller than second average particle size; providing a second fluid comprising at least a third type of particulate material having a third average particle size and a fourth type of particulate material having a fourth average particle size, wherein third average particle size is smaller than fourth average particle size; and introducing the first fluid into the wellbore subsequently followed by introducing the second fluid into the wellbore, wherein the third average particle size is substantially equal to the second average particle size.

In a third aspect, a method for use in a wellbore, comprises: providing a first fluid comprising at least a first type of particulate material having a first average particle size and a second type of particulate material having a second average particle size, wherein first average particle size is smaller than second average particle size; providing a second fluid comprising at least a third type of particulate material having a third average particle size and a fourth type of particulate material having a fourth average particle size, wherein third average particle size is smaller than fourth average particle size; and introducing the first fluid into the wellbore subsequently followed by introducing the second fluid into the wellbore, wherein the fourth average particle size is between the first average particle size and the second average particle size.

In a fourth aspect, a method for use in a wellbore, comprises: providing a first fluid comprising at least a first type of particulate material having a first average particle size and a second type of particulate material having a second average particle size, wherein first average particle size is smaller than second average particle size; providing a second fluid comprising at least a third type of particulate material having a third average particle size and a fourth type of particulate material having a fourth average particle size, wherein third average particle size is smaller than fourth average particle size; and introducing the first fluid into the wellbore subsequently followed by introducing the second fluid into the wellbore, wherein the fourth average particle size is substantially equal to the first average particle size.

### BRIEF DESCRIPTION OF THE DRAWINGS

FIG. 1 shows an illustration of the fluid displacement set up.

FIGS. 2A to 2F show HSCF systems displacing water in the experimental setup.

FIG. 3 shows an illustration of the HSCF systems in an advance and displacement step of water.

FIGS. 4A to 4F and 5A to 5F show HSCF systems displacing other HSCF systems.

FIG. 6 shows fracture geometry estimation for hydraulic fracture calculations for fracture propagation.

FIG. 7 shows computed normalized width according to hydraulic fracture calculations for fracture propagation.

FIG. 8 shows fracture geometry estimation for hydraulic fracture calculations for fracture initiation from a wellbore.

FIG. 9 shows pressurized fracture estimation for hydraulic fracture calculations for fracture initiation from a wellbore.

FIG. 10 shows computed normalized width according to hydraulic fracture calculations for fracture initiation from a wellbore.

FIG. 11 shows a graph of the fracturing initiation pressure versus biggest particle size in the HSCF front.

FIG. 12 shows a graph of the fracturing propagation pressure versus biggest particle size in the HSCF front

### DETAILED DESCRIPTION

The following definitions are provided in order to aid those skilled in the art in understanding the detailed description.

The term “treatment”, or “treating”, refers to any subterranean operation that uses a fluid in conjunction with a desired function and/or for a desired purpose. The term “treatment”, or “treating”, does not imply any particular action by the fluid.

The term “fracturing” refers to the process and methods of breaking down a geological formation and creating a fracture, i.e. the rock formation around a well bore, by pumping fluid at very high pressures, in order to increase production rates from a hydrocarbon reservoir. The fracturing methods otherwise use conventional techniques known in the art.

As mentioned earlier, a PAD fluid is needed for the HSCF to have wide range of applications. The tight requirement of water contents in a HSCF and unique benefits makes it not feasible to use conventional gel PAD fluid. Therefore it is proposed to instead of using a gel or liquid that is solid free as PAD, using fine particle laden slurries as PAD. In this case, the width of a fracture opening does not need to be very large to accommodate the fine particles. As the PAD moves deeper into the fracture, the entrance opening will be widen to accommodate bigger particle laden stage 1 and then stage 2 and eventually accommodate proppant laden slurry. For the flow of different fluids in sequences, it is necessary to adjust the fluid formulations to have the right contrast in properties such as viscosities, density, solid volume fractions (SVF) etc.

A few example fluids are used as model fluids to demonstrate those embodiments. As shown in Table 1, they comprise of different sizes of particles. To minimize the complexities of different properties given by different materials, the particles are all selected to be made of calcium carbonate but with different sizes. Their D50 sizes of each particle are listed in the table. To ensure all particles properly dispersed in aqueous medium, fixed amount of dispersant, which is more than enough to properly disperse the solid in the liquid, are added to the system. Note that sample 1-4 contain only 2 small sizes particles at the same proportion, sample 5-8 contain one larger particle on top of the same small size particles at the same proportions in samples 1-4. Different amount of water was used for each formulation to adjust the solid volume fraction (SVF) of each sample. Sample 1 SVF equals to sample 5 SVF, sample 2 SVF equals sample 6 SVF, and so on so forth. The HSCF densities and viscosities at 170 s⁻¹ (though the fluid is basically Newtonian) are also given in Table 1.

TABLE 1
Example fluid formulations and their basic properties

| Sample ID | | 1 | 2 | 3 | 4 | 5 | 6 | 7 | 8 | 9 |
|---|---|---|---|---|---|---|---|---|---|---|
| Ingredient | Carbolite, 20/40, g | 0 | 0 | 0 | 0 | 0 | 0 | 0 | 0 | 200 |
| | CaCO3, 250μ, g | 0 | 0 | 0 | 0 | 48 | 48 | 48 | 48 | 48 |
| | CaCO3, 20μ, g | 60 | 60 | 60 | 60 | 60 | 60 | 60 | 60 | 60 |
| | CaCO3, 2μ, g | 64 | 64 | 64 | 64 | 64 | 64 | 64 | 64 | 64 |
| | Daxad 17, mL | 5 | 5 | 5 | 5 | 5 | 5 | 5 | 5 | 5 |
| | Water, mL | 32.3 | 28.4 | 25 | 21.5 | 45.6 | 40.2 | 35.6 | 30.8 | 69.0 |

| | | | | | | | | | |
|---|---|---|---|---|---|---|---|---|---|
| Solid volume fraction | 0.57 | 0.60 | 0.63 | 0.66 | 0.57 | 0.60 | 0.63 | 0.66 | 0.66 |
| Density (g/mL) | 1.92 | 2.00 | 2.01 | 2.03 | 1.95 | 1.98 | 2.05 | 2.10 | 2.40 |
| viscosity at 170 s−1 (cP) | 14 | 32 | 41 | 80 | 7 | 8 | 17 | 39 | NA |
| Fluid color | pink | pink | pink | pink | tan | tan | tan | tan | tan |

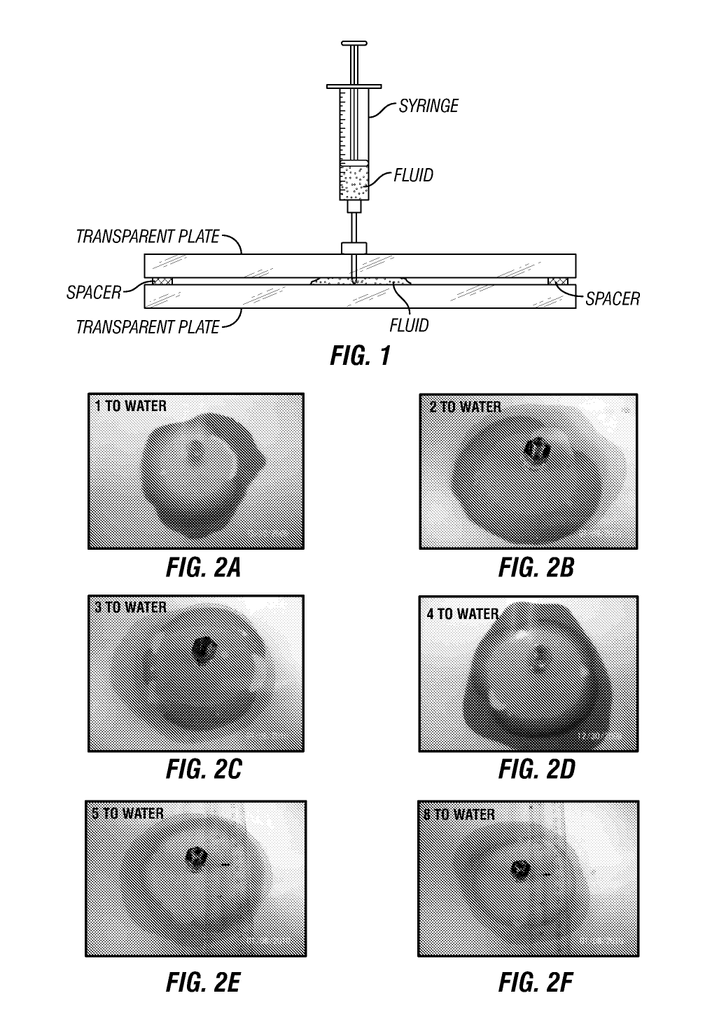

To visualize the fluid displacement and movement, an experiment setup illustrated in FIG. 1 is used. A gap is created between two transparent plexiglass plates. About 5 mL of fluid sample is first injected through a ⅛″ opening in the middle of the top plate. The second sample of ˜5 mL is then injected at fast rate (less than 2 seconds) through the hole again. The second fluid will displace the first on and a roughly circular shaped fluid pattern is created. The resulting displaced fluid patterns are pictured and shown in FIGS. 2-4. To help visualize the fluid interfaces, the samples are dyed with water-soluble colors. Water is dyed green, sample 1-4 are dyed pink and sample 5-8 are in its original tan color.

A summary of the displacement experiment results is presented in Table 2 below. The results in the table are divided into two groups with one group having higher viscosity fluids pushing lower viscosity fluids and the other group in reversed order of fluid placement. The pictures of these experiments are shown in FIGS. 2, 4 and 5.

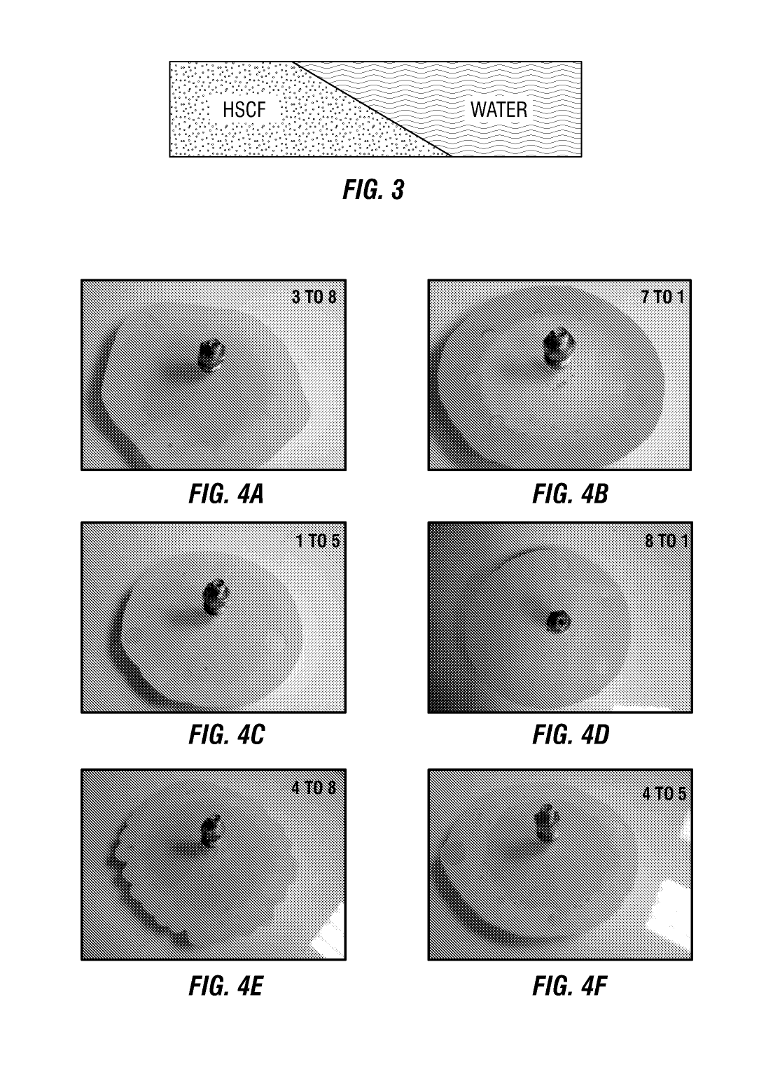

TABLE 2
Fluid displacement test recording

| | | | viscosity | | Density | | |
|---|---|---|---|---|---|---|---|
| Displacement | | | difference | SVF | difference | | Picture in figure |
| type | fluid 1 | fluid 2 | (cP) | difference | (g/mL) | Observation | # (row-column) |
| High | water | 1 | 13 | 0.57 | 0.92 | Circular displacement with | FIG. 2, 1-1 |
| viscosity | | 2 | 31 | 0.60 | 1 | HSCF under-riding the water | FIG. 2, 1-2 |
| push low | | 3 | 40 | 0.63 | 1.01 | layer. | FIG. 2, 2-1 |
| viscosity | | 4 | 79 | 0.66 | 1.03 | | FIG. 2, 2-2 |
| | | 5 | 6 | 0.57 | 0.95 | | FIG. 2, 3-1 |
| | | 8 | 38 | 0.66 | 1.1 | | FIG. 2, 3-2 |
| | 8 | 3 | 2 | −0.03 | 0.09 | Circular displacement with a | FIG. 3, 1-1 |
| | | | | | | few fingering spots. | |
| | 1 | 7 | 3 | 0.06 | 0.13 | Circular displacement with a | FIG. 3, 1-2 |
| | | | | | | few fingering spots. | |
| | 5 | 1 | 7 | 0 | −0.03 | Circular displacement. | FIG. 3, 2-1 |
| | 1 | 8 | 25 | 0.09 | 0.18 | Circular displacement. | FIG. 3, 2-2 |
| | 8 | 4 | 41 | 0 | −0.07 | Circular displacement with | FIG. 3, 3-1 |
| | | | | | | outer boundery not smooth. | |
| | 5 | 4 | 73 | 0.09 | 0.08 | Circular displacement. | FIG. 3, 3-2 |
| Low | 3 | 8 | −2 | 0.03 | −0.09 | Close to even circular | FIG. 4, 1-1 |
| viscosity | | | | | | displacement. | |
| push high | 7 | 1 | −3 | −0.06 | −0.13 | Circular displacement with a | FIG. 4, 1-2 |
| viscosity | | | | | | few fingering spots. | |
| | 1 | 5 | −7 | 0 | 0.03 | Circular displacement with | FIG. 4, 2-1 |
| | | | | | | some points fingered | |
| | 8 | 1 | −25 | −0.09 | −0.18 | Fingering patterns and outer | FIG. 4, 2-2 |
| | | | | | | boundery not smooth. | |
| | 4 | 8 | −41 | 0 | 0.07 | Fingering patterns. | FIG. 4, 3-1 |
| | 4 | 5 | −73 | −0.09 | −0.08 | Completely fingered through. | FIG. 4, 3-2 |

FIG. 2 shows the water being displaced by fluid sample 1-5 and 8. Where water is dyed green color, sample 1-4 are dyed pink and sample 5 and 8 are not dyed. Labels in the picture denote which sample is used to displace water in the experiments. Not surprisingly, we can see that the HSCF samples displaced the water sample evenly since they have higher viscosities. However, we can also note that there is a zone where the fluid mixed to a certain degree with the water as indicated by the differences of color when compared to both the water zone and HSCF zone. Careful examine of the experiment from both the side and the bottom of the setup reveals that the HSCF actually proceeds from the bottom of the gap while leaving water to the top of the interface, i.e. the HSCF under-rode the water, likely due to the density differential between the two fluids. An illustration is shown in FIG. 3.

FIG. 4 shows the displacement pattern of one high viscosity HSCF displacing a low viscosity HSCF. Where sample 1-4 are dyed pink and sample 5 and 8 are not dyed. Labels in the picture denote which fluid sample is used to displace which other fluid in the experiments. The viscosity differences are going from low to high from left to right and top to bottom in the figure. From the pictures one can see that the second fluids (higher in viscosity) continuously displaced the first fluids without any second fluid breaking through the first one, which is in agreement with normal high viscosity fluids displacing low viscosity fluid observations. This is important as it will prevent one size of solid laden slurry to move ahead of the PAD-like slurry before it when fracture width is not yet wide enough to accommodate the large particles. It can also be observed that when the densities are very close to each other, such as sample 1 to 5 (FIG. 4, 2-1), the boundary is very clear, indicating there is no under-riding or over-riding happening when one fluid is pushing the other. While high density differential (8 to 1, FIG. 4, 2-2) the interface layer boundary is ill-defined, indicating uneven advancement of the fluid, which in longer flowing distance may lead to mixing.

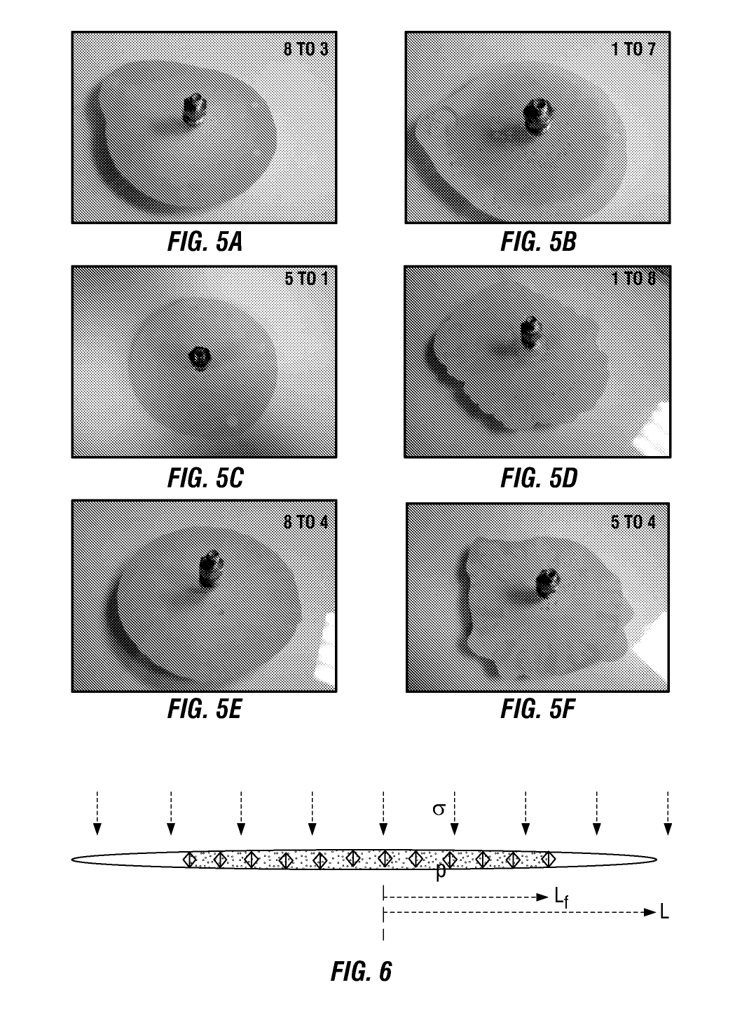

FIG. 5 shows the displacement pattern of one low viscosity HSCF displacing a high viscosity HSCF. Where sample 1-4 are dyed pink and sample 5 and 8 are not dyed. Labels in the picture denote which fluid sample is used to displace which other fluid in the experiments. The viscosity differences are going from low to high from left to right and top to bottom in the figure. From the pictures one can see that the second fluids (lower in viscosity) are displacing the first fluids unevenly, i.e. fingering, which is in agreement with normal low viscosity fluids displacing high viscosity fluid observations. When the viscosity difference is not big, such as in FIG. 5, 1-1, 8 to 3, fingering is not obvious to big viscosity difference as in FIG. 5, 3-3, 5 to 4, the second fluid completely breaks through the ring formed by the first fluid. This proves from the other side that it is important to formulate the viscosity contrast between a particle laden PAD and a proppant laden slurry. It can also be observed that density differential does not play as important a role as the viscosity difference.

Although other than HSCF displacing water, high SVF differential scenario has not been explored in this experiment but is believed to follow common wisdom where bigger SVF differential HSCF has higher tendency to mix while closer SVF slurries are less likely to mix.

Given the nature of tight requirement of the fluid water content for HSCF, another concern on using different fluids (slurries) in sequence in a pumping treatment is that if they were mixed down the flow path, the resulting mixture is still stable to suspend and transport the proppant. For that purpose, we have formulated fluid 9 with 20/40 mesh Carbolite proppant. Sample 9 is mixed with sample 1, 4, 5 and 8 in the bottle and checked for stability and flow ability. Within 24 hours, the mixtures have no observed separation and the fluid is very flow-able. While on the other hand, if fluid 9 is mixed with less than 10% of water, the proppant completely settles to the bottom of the container within minutes and the resulting separated slurry cannot flow as desired. This result shows that even if the HSCF fluids were mixed, within a certain SVF variations, the fluid still behaves as an acceptable HSCF that can suspend and transport proppant.

From these experiments, it is suggested that we can formulate fracturing fluid consist of only HSCF but with different formulations. The front PAD fluid should contain finest particles and the gradually change to coarser particles. If needed, the front PAD fluid can also be designed to have the best fluid leakoff control. The transition has to ensure proper viscosity, SVF and density gradient. The fluid formulations have to ensure that the viscosity of the later fluid be no less than that of the fluid in front of it, have similar SVF, and similar density. Satisfying these conditions will ensure minimum mixing between fluids and proper fracture and proppant placement. If needed, same criteria can be used in the reverse order for the flush fluid.

The first or second fluid can be a treatment fluid. The treatment fluid can be embodied as a fracturing slurry wherein the fluid is a carrier fluid. The carrier fluid includes any base fracturing fluid understood in the art. Some non-limiting examples of carrier fluids include hydratable gels (e.g. guars, poly-saccharides, xanthan, hydroxy-ethyl-cellulose, etc.), a cross-linked hydratable gel, a viscosified acid (e.g. gel-based), an emulsified acid (e.g. oil outer phase), an energized fluid (e.g. an N₂ or CO₂ based foam), and an oil-based fluid including a gelled, foamed, or otherwise viscosified oil. Additionally, the carrier fluid may be a brine, and/or may include a brine.

While the first or second fluid described herein includes particulates, the fluid may further include certain stages of fracturing fluids with alternate mixtures of particulates.

A low amount of viscosifier specifically indicates a lower amount of viscosifier than conventionally is included for a fracture treatment. The loading of the viscosifier, for example described in pounds of gel per 1,000 gallons of carrier fluid, is selected according to the particulate size (due to settling rate effects) and loading that the fracturing slurry must carry, according to the viscosity required to generate a desired fracture geometry, according to the pumping rate and casing or tubing configuration of the wellbore, according to the temperature of the formation of interest, and according to other factors understood in the art. In certain embodiments, the low amount of the viscosifier includes a hydratable gelling agent in the carrier fluid at less than 20 pounds per 1,000 gallons of carrier fluid where the amount of particulates in the fracturing slurry are greater than 16 pounds per gallon of carrier fluid. In certain further embodiments, the low amount of the viscosifier includes a hydratable gelling agent in the carrier fluid at less than 20 pounds per 1,000 gallons of carrier fluid where the amount of particulates in the fracturing slurry are greater than 23 pounds per gallon of carrier fluid. In certain embodiments, a low amount of the viscosifier includes a visco-elastic surfactant at a concentration below 1% by volume of carrier fluid. In certain embodiments a low amount of the viscosifier includes values greater than the listed examples, because the circumstances of the fluid conventionally utilize viscosifier amounts much greater than the examples. For example, in a high temperature application with a high proppant loading, the carrier fluid may conventionally indicate the viscosifier at 50 lbs of gelling agent per 1,000 gallons of carrier fluid, wherein 40 lbs of gelling agent, for example, may be a low amount of viscosifier. One of skill in the art can perform routine tests of fracturing slurries based on certain particulate blends in light of the disclosures herein to determine acceptable viscosifier amounts for a particular embodiment of the fluid.

In certain embodiments, the fluid includes an acid. The fracture is illustrated as a traditional hydraulic double-wing fracture, but in certain embodiments may be an etched fracture and/or wormholes such as developed by an acid treatment. The carrier fluid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In certain embodiments, the carrier fluid includes a poly-amino-poly-carboxylic acid, and is a trisodium hydroxyl-ethyl-ethylene-diamine triacetate, mono-ammonium salts of hydroxyl-ethyl-ethylene-diamine triacetate, and/or mono-sodium salts of hydroxyl-ethyl-ethylene-diamine tetra-acetate. The selection of any acid as a carrier fluid depends upon the purpose of the acid—for example formation etching, damage cleanup, removal of acid-reactive particles, etc., and further upon compatibility with the formation, compatibility with fluids in the formation, and compatibility with other components of the fracturing slurry and with spacer fluids or other fluids that may be present in the wellbore.

In certain embodiments, the fracturing slurry includes particulate materials generally called proppant. Proppant involves many compromises imposed by economical and practical considerations. Criteria for selecting the proppant type, size, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated, or pre-cured resin coated. Proppants and gravels in the same or different wells or treatments can be the same material and/or the same size as one another and the term proppant is intended to include gravel in this disclosure. In general the proppant used will have an average particle size of from about 0.15 mm to about 2.39 mm (about 8 to about 100 U.S. mesh), more particularly, but not limited to 0.25 to 0.43 mm (40/60 mesh), 0.43 to 0.84 mm (20/40 mesh), 0.84 to 1.19 mm (16/20), 0.84 to 1.68 mm (12/20 mesh) and 0.84 to 2.39 mm (8/20 mesh) sized materials. Normally the proppant will be present in the slurry in a concentration of from about 0.12 to about 0.96 kg/L, or from about 0.12 to about 0.72 kg/L, or from about 0.12 to about 0.54 kg/L.

In one embodiment, the first and second fluid comprises particulate materials with defined particles size distribution. On example of realization is disclosed in U.S. publication number 2009-0025934, for a treatment fluid being a fracturing slurry. The first fluid may include a first amount of particulates having a first average particle size between about 5 μm and 2000 μm. In certain embodiments, the first amount of particulates may be a fluid loss agent, for example calcium carbonate particles or other fluid loss agents known in the art. The first fluid may further include a second amount of particulates having a second average particle size between about three times and about ten times greater than the first average particle size. For example, where the second average particle size is about 100 μm (an average particle diameter, for example), the first average particle size may be between about 5 μm and about 33 μm. In certain embodiments, the first average particle size may be between about seven and twenty times smaller than the second average particle size.

The second fluid may include a third amount of particulates having a third average particle size between about 5 μm and 5000 μm. In certain embodiments, the third amount of particulates may be a proppant, for example sand, ceramic, or other particles understood in the art to hold a fracture open after a treatment is completed In certain embodiments, the third amount of particulates may be a fluid loss agent, for example calcium carbonate particles or other fluid loss agents known in the art. The third fluid may further include a fourth amount of particulates having a fourth average particle size between about three times and about ten times greater than the third average particle size. For example, where the fourth average particle size is about 600 μm (an average particle diameter, for example), the third average particle size may be between about 50 μm and about 200 μm. In certain embodiments, the third average particle size may be between about seven and twenty times smaller than the fourth average particle size.

In a second embodiment, the selection of the size of the second amount of particulates is dependent upon maximizing the packed volume fraction (PVF) of the mixture of the first amount of particulates and the second amount of particulates. A second average particle size of between about five to ten times smaller than the first amount of particulates contributes to maximizing the PVF of the mixture, but a size between about three to ten times smaller, and in certain embodiments between about three to twenty times smaller, will provide a sufficient PVF for most systems. Further, the selection of the size of the second amount of particulates is dependent upon the composition and commercial availability of particulates of the type comprising the second amount of particulates. For example, where the second amount of particulates comprise wax beads, a second average particle size of four times (4×) smaller than the first average particle size rather than seven times (7×) smaller than the first average particle size may be used if the 4× embodiment is cheaper or more readily available and the PVF of the mixture is still sufficient to acceptably suspend the particulates in the carrier fluid.

In certain embodiments, the first or second fluid includes a degradable material. In certain embodiments, the degradable material is making up at least part of the amount of particulates. In certain embodiments, the first or second fluid includes a viscosifier material.

In certain embodiments, the degradable material includes at least one of a lactide, a glycolide, an aliphatic polyester, a poly (lactide), a poly (glycolide), a poly (ε-caprolactone), a poly (orthoester), a poly (hydroxybutyrate), an aliphatic polycarbonate, a poly (phosphazene), and a poly (anhydride). In certain embodiments, the degradable material includes at least one of a poly (saccharide), dextran, cellulose, chitin, chitosan, a protein, a poly (amino acid), a poly (ethylene oxide), and a copolymer including poly (lactic acid) and poly (glycolic acid). In certain embodiments, the degradable material includes a copolymer including a first moiety which includes at least one functional group from a hydroxyl group, a carboxylic acid group, and a hydrocarboxylic acid group, the copolymer further including a second moiety comprising at least one of glycolic acid and lactic acid.

In some embodiments, the fluids may optionally further comprise additional additives, including, but not limited to, acids, fluid loss control additives, gas, corrosion inhibitors, scale inhibitors, catalysts, clay control agents, biocides, friction reducers, combinations thereof and the like. For example, in some embodiments, it may be desired to foam the fluids using a gas, such as air, nitrogen, or carbon dioxide. In one certain embodiment, the fluids may contain a particulate additive, such as a particulate scale inhibitor.

The fluids may be used for carrying out a variety of subterranean treatments, including, but not limited to, drilling operations, fracturing treatments, and completion operations (e.g., gravel packing). In some embodiments, the fluids may be used in treating a portion of a subterranean formation. In certain embodiments, the fluids may be introduced into a well bore that penetrates the subterranean formation. Optionally, the fluids further may comprise particulates and other additives suitable for treating the subterranean formation.

To facilitate a better understanding of the embodiments, the following examples are given. In no way should the following examples be read to limit, or define, the scope of the invention.

### EXAMPLES

To demonstrate that the HSCF PAD using reduced particles size can make it easier for hydraulic fracture with HSCF, some numeric scenarios examples are given herewith. These calculations provide an estimate of hydraulic fracture width at fluid front in order to estimate the minimum pressure required to propagate the fracture when using a HSCF slurry.

To do this estimate, we make the following simplifications: (1) The hydraulic fracture is approximated as a 2D crack under plane strain condition. The fracture geometry is as shown in FIG. 6; (2) The fluid pressure inside fracture is approximated by a constant pressure p; (3) A fluid lag zone exists ahead of the fluid front. This is especially the case for HSCF since the width near the fracture tip is too small to accept solid particles in HSCF. The pressure in the fluid lag zone is assumed to be zero.

In FIG. 6, σ is the in-situ stress acting on the fracture, L is the half length of the fracture, and L_{f} is the distance from wellbore to the fluid front. With the above assumptions, the width profile along the fracture can be obtained analytically, following the work by Geertsma and de Klerk, Geertsma, J. and de Klerk, F., “A Rapid Method of Predicting Width and Extent of Hydraulically Induced Fractures,” JPT, December 1969, pp 1571-1581. Specifically, we can obtain the fracture width at the fluid front (at x=L_{f}) as given below:

$${W}_{f} = - \frac{8}{π {E}^{′}} p L {f}_{l 0} ln {f}_{l 0}$$

where W_{f} is the width at fluid front, E′ is plane strain elastic modulus and

$${f}_{l 0} = \frac{{L}_{f}}{L} = sin \frac{π}{2} \frac{σ}{p}$$

For a given in-situ stress, elastic modulus, fracture length and a specified W_{f}, the required fluid pressure p can be calculated from the above equations. In order to propagate a hydraulic fracture with HSCF, W_{f} must exceed at least one particle diameter dp. Otherwise, the slurry cannot move forward in the fracture and the pressure inside the fracture has to increase until the width exceeds the particle diameter in order for the slurry to push forward. Therefore, by letting W_{f}=dp, one can get an estimate of the minimum pressure to be expected when fracturing with a HSCF slurry using the above equations.

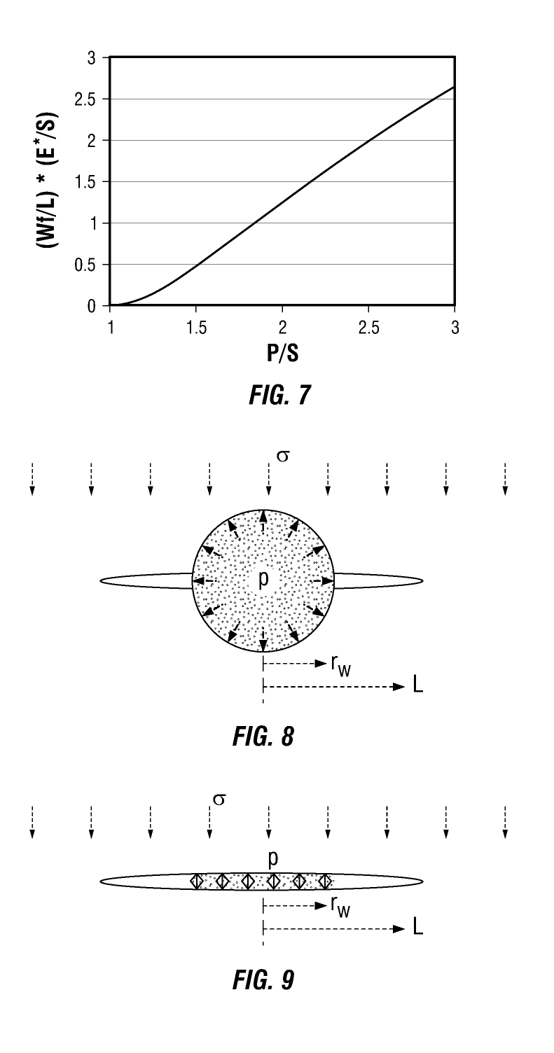

FIG. 7 shows the computed normalized width, W_{f}/L*E′/σ, vs. p/σ. For a given normalized width, one can find the required pressure from the chart.

### Example 1

The following is an example that helps illustrate the usage of this calculation. The following input parameters are assumed:

| E′ | 2.0e6 | psi |
|---|---|---|
| σ | 4000 | psi |
| L | 50 | ft |
| dp | 0.01 | in |

With these parameters, W_{f}/L*E′/σ=8.33e-3, and p/σ can be determined to be 1.053. This leads to a net pressure (p−σ) of 212 psi. This net pressure is of the same order as in a typical hydraulic fracturing pressure. This implies that for this particle size and a fracture that has developed sufficient length exceeding 50 ft, the fracture width is sufficient to accept the particles without requiring an excessive pressure.

For fracture initiation from a wellbore, the pressurization of the wellbore needs to be taken into consideration. FIG. 8 illustrates the geometry of fracture under consideration. To estimate the fracture opening at the entrance to the fracture, we make the approximation of representing the pressurized well as a pressurized fracture segment with the length equal to the wellbore diameter, as illustrated in FIG. 9. With this approximation, the width calculation based on Geertsma and de Klerk can be used again, which leads to the following:

$${W}_{f} = - \frac{8}{π {E}^{′}} p {r}_{w} ln {f}_{l 0}$$

$${f}_{l 0} = \frac{{r}_{w}}{L} = sin \frac{π}{2} \frac{σ}{p}$$

Where r_{w} is wellbore radius.

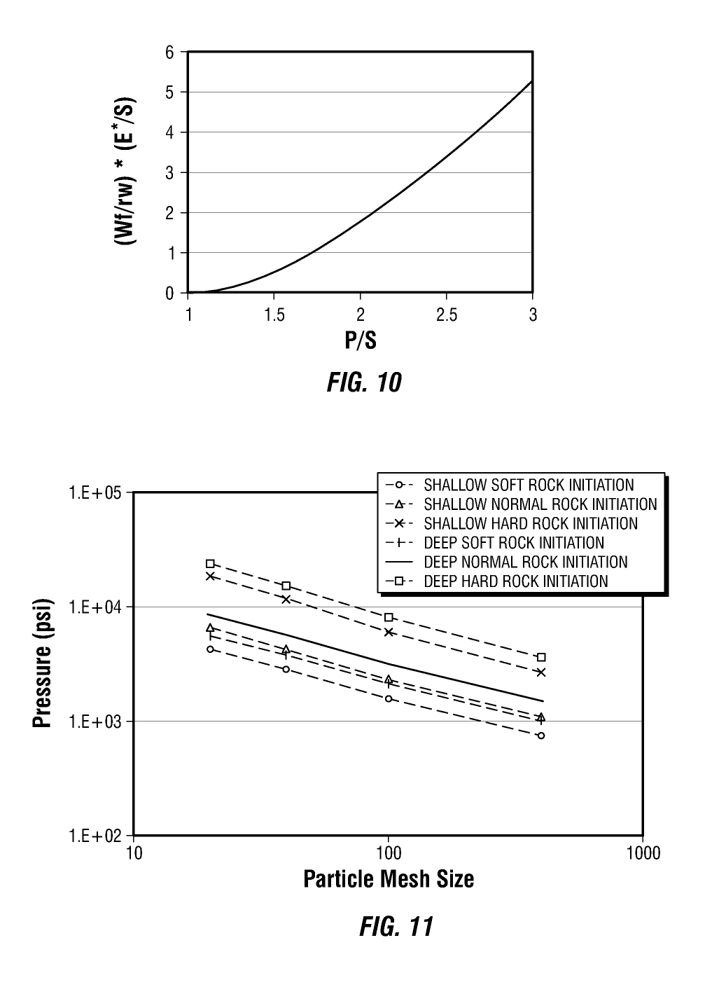

Similar to the propagation case, FIG. 10 shows the computed normalized width, W_{f}/r_{w}*E′/σ, vs. p/σ. For a given normalized width, one can find the required pressure from the chart.

### Example 2

The following is a second example, all parameters are the same as in previous example, and r_{w}=0.5 ft. We can calculate that W_{f}/r_{w}*E′/σ=0.833, and p/σ is determined to be 1.64. This leads to a net pressure of 2560 psi. This pressure is quite high, but not unrealistic when first initiating a fracture.

To avoid high fracturing pressure, a HSCF with small particles can be used. Using the equations above, one can estimate the expected pressure. The particle size can be optimized so an acceptable pressure can be achieved.

### Example 3

With this calculation method, we have made estimations of the fracture initiation pressure and propagation pressure under few different scenarios.

Formation depth: shallow wells corresponding to a 5000 psi closure stress and deep wells corresponding to a 10,000 psi closure stress.

Formation hardness: soft rock with Young's modulus of 0.5 Mpsi, normal rock with 1 Mpsi, and hard rock with 5 Mpsi.

Biggest particle sizes used to make the HSCF PAD: 20, 40, 100 and 400 mesh.

HSCF has high solid content, so based on the literature; we used 2.5 particles to bridge at the front of the fracture for these simulations. In the simulations, 0.5 ft fracture length or wellbore adding perforation is used to calculate the fracture initiation pressure and 50 ft fracture length is used for fracture propagation pressure.

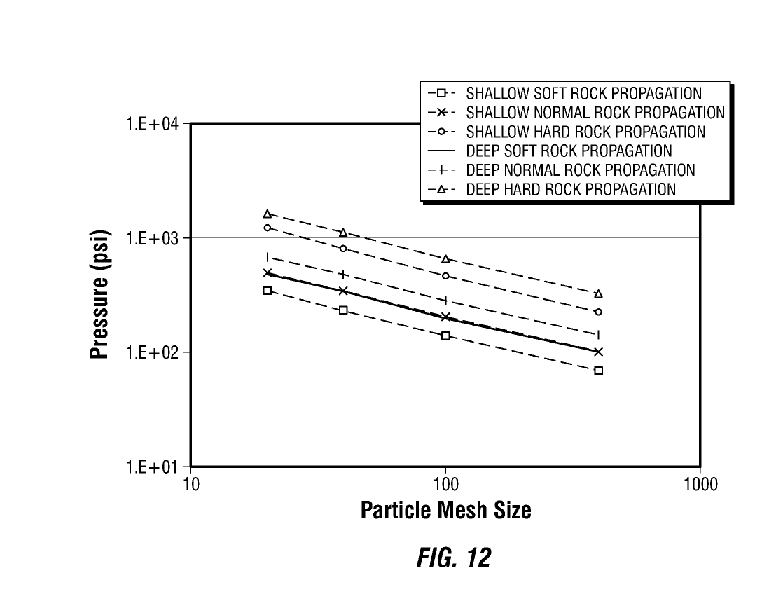

The scenario simulation results are listed in Table 3 below and FIGS. 11 and 12.

A few observations are obvious from these results.

1. It is not feasible to use HSCF with big particles to do hydraulic fracture treatment if the formation is not soft and shallow.
2. The fluid initiation pressure (a few thousands) is much higher than the propagation pressure (normally a few hundred).
3. Under the same environment, reducing the particle sizes help greatly in reducing the initiation and propagation pressure.
4. When the fracture is opened with the small particle HSCF, the fluid can easily be propagated, even with the big particles such as 20/40 mesh proppants and this fluid has moved to the very front.

Numerically, these scenario simulations demonstrated the concept of using the small particle PAD can make the HSCF fracturing possible.

To check with reality based on these simulation results, 3000 psi net pressure to initiate a fracture is not uncommonly seen in the field operations. So based on this standard, in the shallow soft rock, even a HSCF with 40/60 mesh proppant can initiate the fracture, i.e. this can be a true pad-less treatment. In deep hard rock formation, fracture can still be initiated with a little less than 400 mesh particle pad.

TABLE 3
Scenario simulation results

| | Young's modulus | Paticle size | Net pressure (psi) | |
|---|---|---|---|---|
| Stress (psi) | (Mpsi) | (mesh) | initiation | propagation |
| 5000 | 0.5 | 20 | 4305 | 343 |
| 5000 | 0.5 | 40 | 2845 | 240 |
| 5000 | 0.5 | 100 | 1585 | 142 |
| 5000 | 0.5 | 400 | 750 | 71 |
| 5000 | 1 | 20 | 6595 | 493 |
| 5000 | 1 | 40 | 4295 | 343 |
| 5000 | 1 | 100 | 2345 | 202 |
| 5000 | 1 | 400 | 1094 | 101 |
| 5000 | 5 | 20 | 18900 | 1183 |
| 5000 | 5 | 40 | 11865 | 803 |
| 5000 | 5 | 100 | 6135 | 464 |
| 5000 | 5 | 400 | 2695 | 228 |
| 10000 | 0.5 | 20 | 5700 | 480 |
| 10000 | 0.5 | 40 | 3830 | 337 |
| 10000 | 0.5 | 100 | 2170 | 200 |
| 10000 | 0.5 | 400 | 1050 | 100 |
| 10000 | 1 | 20 | 8600 | 686 |
| 10000 | 1 | 40 | 5700 | 479 |
| 10000 | 1 | 100 | 3170 | 284 |
| 10000 | 1 | 400 | 1500 | 142 |
| 10000 | 5 | 20 | 23800 | 1609 |
| 10000 | 5 | 40 | 15200 | 1107 |
| 10000 | 5 | 100 | 8030 | 646 |
| 10000 | 5 | 400 | 3630 | 320 |

What is claimed is:

1. A method for use in a wellbore, comprising:
a. providing a first fluid comprising at least a first type of particulate material having a first average particle size and a second type of particulate material having a second average particle size, wherein first average particle size is smaller than second average particle size;
b. providing a second fluid comprising at least a third type of particulate material having a third average particle size and a fourth type of particulate material having a fourth average particle size, wherein third average particle size is smaller than fourth average particle size; and
c. introducing the first fluid into the wellbore subsequently followed by introducing the second fluid into the wellbore, wherein one the following conditions selected from the group consisting of {third average particle size is between first average particle size and second average particle size}, {third average particle size is substantially equal to second average particle size}, {fourth average particle size is between first average particle size and second average particle size}, and {fourth average particle size is substantially equal to first average particle size} is meet.

2. The method of claim 1, wherein the first fluid further comprises a fifth type of particulate material having a fifth average particle size.

3. The method of claim 1 or 2, wherein the second fluid further comprises a sixth type of particulate material having a sixth average particle size.

4. A method for use in a wellbore, comprising:
a. providing a first fluid comprising at least a first type of particulate material having a first average particle size and a second type of particulate material having a second average particle size, wherein first average particle size is smaller than second average particle size;
b. providing a second fluid comprising at least a third type of particulate material having a third average particle size and a fourth type of particulate material having a fourth average particle size, wherein third average particle size is smaller than fourth average particle size; and
c. introducing the first fluid into the wellbore subsequently followed by introducing the second fluid into the wellbore, wherein the third average particle size is substantially equal to the second average particle size.

5. The method of claim 4, wherein the first fluid is a treatment fluid.

6. The method of claim 5, wherein the first fluid is a pad.

7. The method of claim 4, 5 or 6, wherein the second fluid is a hydraulic fracturing fluid.

8. The method of claim 7, wherein third type or fourth type of particulate materials is proppant.

9. The method according to anyone of claims 4 to 8, wherein the first fluid further comprises a fifth type of particulate material having a fifth average particle size.

10. The method according to anyone of claims 4 to 9, wherein the second fluid further comprises a sixth type of particulate material having a sixth average particle size.

11. The method according to anyone of claims 4 to 10, wherein the first average particle size is between five to ten times smaller than the second average particle size.

12. The method according to anyone of claims 4 to 11, wherein the third average particle size is between five to ten times smaller than the fourth average particle size.

13. The method according to anyone of claims 4 to 12, wherein third type or fourth type of particulate materials is a degradable particulate material.

14. The method according to anyone of claims 4 to 13, wherein first type or second type of particulate materials is a degradable particulate material.

15. The method according to anyone of claims 4 to 14, wherein the second fluid further comprises a viscosifier material.

16. A method for use in a wellbore, comprising:
a. providing a first fluid comprising at least a first type of particulate material having a first average particle size;
b. providing a second fluid comprising at least a third type of particulate material having a third average particle size and a fourth type of particulate material having a fourth average particle size, wherein third average particle size is smaller than fourth average particle size; and
c. introducing the first fluid into the wellbore subsequently followed by introducing the second fluid into the wellbore, wherein the third average particle size is substantially equal to the first average particle size.

17. The method of claim 16, wherein the first fluid is a treatment fluid.

18. The method of claim 17, wherein the first fluid is a pad.

19. The method of claim 16, 17 or 18, wherein the second fluid is a hydraulic fracturing fluid.

20. The method of claim 19, wherein third type or fourth type of particulate materials is proppant.

21. The method according to anyone of claims 16 to 20, wherein the first fluid further comprises a second type of particulate material having a second average particle size

22. The method of claim 21, wherein the first fluid further comprises a fifth type of particulate material having a fifth average particle size.

23. The method according to anyone of claims 16 to 22, wherein the second fluid further comprises a sixth type of particulate material having a sixth average particle size.

24. A method for use in a wellbore, comprising:
a. providing a first fluid comprising at least a first type of particulate material having a first average particle size and a second type of particulate material having a second average particle size, wherein first average particle size is smaller than second average particle size;
b. providing a second fluid comprising at least a third type of particulate material having a third average particle size; and
c. introducing the first fluid into the wellbore subsequently followed by introducing the second fluid into the wellbore.

25. The method of claim 24, wherein the second average particle size is smaller than the third average particle size.

26. The method of claim 24 or 25, wherein the third average particle size is substantially equal to the second average particle size

27. The method of claim 24, 25 or 26, wherein the first fluid is a treatment fluid.

28. The method according to anyone of claims 24 to 27, wherein the first fluid is a pad.

29. The method of claim 24, wherein the second fluid is a hydraulic fracturing fluid.
